(19) United States
(12) Patent Application Publication
(10) Pub. No.: US 2026/0039405 A1
(43) Pub. Date: Feb. 5, 2026

(54) TIME WINDOW-BASED CROSS-LINK INTERFERENCE MEASUREMENT AND REPORTING

(71) Applicant: QUALCOMM Incorporated, San Diego, CA (US)

(72) Inventors: Qian ZHANG, Basking Ridge, NJ (US); Jae Ho RYU, San Diego, CA (US); Muhammad Sayed Khairy ABDELGHAFFAR, San Jose, CA (US)

(21) Appl. No.: 18/791,163

(22) Filed: Jul. 31, 2024

(51) Int. Cl. H04B 17/309; H04B 17/318; H04L 5/00

(52) U.S. Cl. CPC H04B 17/346; H04B 17/328; H04L 5/0051

(57) ABSTRACT

Methods, systems, and devices for wireless communications are described. Generally, the described techniques may enable a user equipment (UE) to receive a configuration message that may configure a set of cross-link interference resources, where each CLI resource may be configured with a respective slot offset. Based on receiving a control message, the UE may monitor and report the CLI resources in accordance with their respective slot offsets. Additionally, or alternatively, the UE may receive a control message that triggers a time window for the UE to monitor and measure any CLI resources that occurs within the time window. The UE may report a quantity of measurements (e.g., the N strongest or N weakest) in the time window, which may be associated with a quantity (e.g., the N strongest or N weakest) of aggressor UEs.

### FIELD OF TECHNOLOGY

The following relates to wireless communications, including time window-based cross-link interference measurement and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some cases, communications at one communication device may cause cross link interference (CLI) at another communication device.

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving a control message that triggers one or more aperiodic cross-link interference received signal strength indicator (CLI-RSSI) resources, one or more aperiodic CLI sounding reference signal received power (SRS-RSRP) resources, or a CLI measurement time window, for a layer one (L1) UE to UE CLI measurement, where the CLI measurement time window corresponds to one or more time and frequency locations and performing the L1 UE to UE CLI measurement on the one or more aperiodic CLI-RSSI resources, the one or more aperiodic CLI SRS-RSRP resources, or during the CLI measurement time window.

A UE for wireless communication is described. The UE may include one or more memories storing processor executable code, and one or more processors coupled with the one or more memories. The one or more processors may individually or collectively be operable to execute the code to cause the UE to receive a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations and perform the L1 UE to UE CLI measurement on the one or more aperiodic CLI-RSSI resources, the one or more aperiodic CLI SRS-RSRP resources, or during the CLI measurement time window.

Another UE for wireless communication is described. The UE may include means for receiving a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations and means for performing the L1 UE to UE CLI measurement on the one or more aperiodic CLI-RSSI resources, the one or more aperiodic CLI SRS-RSRP resources, or during the CLI measurement time window.

A non-transitory computer-readable medium storing code for wireless communication is described. The code may include instructions executable by one or more processors to receive a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations and perform the L1 UE to UE CLI measurement on the one or more aperiodic CLI-RSSI resources, the one or more aperiodic CLI SRS-RSRP resources, or during the CLI measurement time window.

Some examples of the method, UEs, and non-transitory computer-readable medium described herein may further include operations, features, means, or instructions for receiving a configuration message that indicates a set of CLI-RSSI resources or a set of CLI SRS-RSRP resources, and where the configuration message indicates a respective resource level slot offset for each respective CLI-RSSI resource of the set of CLI-RSSI resources or for each respective CLI SRS-RSRP resource of the set of CLI SRS-RSRP resources, where the L1 UE to UE CLI measurement may be performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources according to the respective resource level slot offset for each of one or more aperiodic CLI-RSSI resources or the one or more aperiodic CLI SRS-RSRP resources.

In some examples of the method, UEs, and non-transitory computer-readable medium described herein, the control message may be associated with a CLI measurement time window associated with the one or more aperiodic CLI-RSSI resources or the one or more aperiodic CLI SRS-RSRP resources for the L1 UE to UE CLI measurement and the L1 UE to UE CLI measurement may be performed on the one or more aperiodic CLI-RSSI resources or the one or more aperiodic CLI SRS-RSRP resources during the CLI measurement time window.

In some examples of the method, UEs, and non-transitory computer-readable medium described herein, each respective slot associated with the one or more aperiodic CLI-RSSI resources or the one or more aperiodic CLI SRS-RSRP resources occurs during the CLI measurement time window.

Some examples of the method, UEs, and non-transitory computer-readable medium described herein may further include operations, features, means, or instructions for obtaining a set of L1 UE to UE CLI measurement values based on the L1 UE to UE CLI measurement performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources that occurs during the CLI measurement time window and transmitting a report including one or more L1 UE to UE CLI measurement values of the set of L1 UE to UE CLI measurement values based on the configuration message.

In some examples of the method, UEs, and non-transitory computer-readable medium described herein, the set of L1 UE to UE CLI measurement values includes one or more RSRP values, one or more RSSI values, or a combination thereof. In some examples of the method, UEs, and non-transitory computer-readable medium described herein, the one or more L1 UE to UE CLI measurement values satisfy a threshold L1 UE to UE CLI measurement value.

In some examples of the method, UEs, and non-transitory computer-readable medium described herein, the configuration message indicates a quantity of CLI-RSSI resources or CLI SRS-RSRP resources for reporting L1 UE to UE CLI measurement and the report may be transmitted based on the quantity of CLI-RSSI resources or CLI SRS-RSRP resources indicated in the configuration message. In some examples of the method, UEs, and non-transitory computer-readable medium described herein, one or more reporting criterion associated with the report may be based on a quantity of most interfering or least interfering CLI-RSSI resources or CLI SRS-RSRP resources.

Some examples of the method, UEs, and non-transitory computer-readable medium described herein may further include operations, features, means, or instructions for identifying a respective resource set level slot offset for the set of CLI-RSSI resources or the set of CLI SRS-RSRP resources, where the respective resource level slot offset may be applicable for the set of CLI-RSSI resources or the set of CLI SRS-RSRP resources and bypassing a usage of the respective resource set level slot offset for the set of CLI-RSSI resources or the set of CLI SRS-RSRP resources based on the respective resource level slot offset for each respective CLI-RSSI resource of the set of CLI-RSSI resources or for each respective CLI SRS-RSRP resource of the set of CLI SRS-RSRP resources, where the L1 UE to UE CLI measurement may be performed on the one or more aperiodic CLI-RSSI resources or the one or more aperiodic CLI SRS-RSRP resources based on the bypassing.

Some examples of the method, UEs, and non-transitory computer-readable medium described herein may further include operations, features, means, or instructions for receiving a configuration message that indicates a set of CLI-RSSI resources or a set of CLI SRS-RSRP resources, the set of CLI-RSSI resources or the set of CLI SRS-RSRP resources including a set of multiple CLI-RSSI resources or CLI SRS-RSRP resources, respectively, where the configuration message indicates a different slot for each CLI-RSSI resource of the set of multiple CLI-RSSI resources or each CLI SRS-RSRP resource of the set of multiple CLI SRS-RSRP resources.

In some examples of the method, UEs, and non-transitory computer-readable medium described herein, the control message indicates a time duration between an ending slot associated with the control message and a beginning slot associated with the CLI measurement time window. In some examples of the method, UEs, and non-transitory computer-readable medium described herein, the control message indicates a length of the CLI measurement time window.

In some examples of the method, UEs, and non-transitory computer-readable medium described herein, the control message indicates a quantity of symbols per slot to monitor and measure associated with the one or more aperiodic CLI-RSSI resources or the one or more aperiodic CLI SRS-RSRP resources and the quantity of symbols per slot may be indicated via a bitmap or an indication of one or more symbol numbers.

In some examples of the method, UEs, and non-transitory computer-readable medium described herein, the control message indicates a quantity of subbands or bands to monitor and measure associated with the one or more aperiodic CLI-RSSI resources or the one or more aperiodic CLI SRS-RSRP resources for the L1 UE to UE CLI measurement.

In some examples of the method, UEs, and non-transitory computer-readable medium described herein, the L1 UE to UE CLI measurement performed on the one or more aperiodic CLI-RSSI resources or the one or more aperiodic CLI SRS-RSRP resources may be associated with a set of multiple neighbor UEs, a set of multiple receive beams, a set of multiple transmit beams, or a combination thereof.

Some examples of the method, UEs, and non-transitory computer-readable medium described herein may further include operations, features, means, or instructions for transmitting a capability message indicating a capability of the UE to support the L1 UE to UE CLI measurement on the one or more aperiodic CLI-RSSI resources or the one or more aperiodic CLI SRS-RSRP resources during the CLI measurement time window, where the control message may be based on the capability message.

A method for wireless communication by a UE is described. The method may include receiving a configuration message that indicates a time window for an L1 UE to UE CLI measurement, where the configuration message indicates one or more time and frequency locations associated with the CLI measurement time window, receiving a control message that triggers the CLI measurement time window for the L1 UE to UE CLI measurement, and performing the L1 UE to UE CLI measurement during the CLI measurement time window.

A UE for wireless communication is described. The UE may include one or more memories storing processor executable code, and one or more processors coupled with the one or more memories. The one or more processors may individually or collectively be operable to execute the code to cause the UE to receive a configuration message that indicates a time window for an L1 UE to UE CLI measurement, where the configuration message indicates one or more time and frequency locations associated with the CLI measurement time window, receive a control message that triggers the CLI measurement time window for the L1 UE to UE CLI measurement, and perform the L1 UE to UE CLI measurement during the CLI measurement time window.

Another UE for wireless communication is described. The UE may include means for receiving a configuration message that indicates a time window for an L1 UE to UE CLI measurement, where the configuration message indicates one or more time and frequency locations associated with the CLI measurement time window, means for receiving a control message that triggers the CLI measurement time window for the L1 UE to UE CLI measurement, and means for performing the L1 UE to UE CLI measurement during the CLI measurement time window.

A non-transitory computer-readable medium storing code for wireless communication is described. The code may include instructions executable by one or more processors to receive a configuration message that indicates a time window for an L1 UE to UE CLI measurement, where the configuration message indicates one or more time and frequency locations associated with the CLI measurement time window, receive a control message that triggers the CLI measurement time window for the L1 UE to UE CLI measurement, and perform the L1 UE to UE CLI measurement during the CLI measurement time window.

Some examples of the method, UEs, and non-transitory computer-readable medium described herein may further include operations, features, means, or instructions for obtaining a set of L1 UE to UE CLI measurement values based on the L1 UE to UE CLI measurement performed on one or more aperiodic CLI-RSSI resources or one or more aperiodic CLI SRS-RSRP resources and during each respective slot associated with the one or more aperiodic CLI-RSSI resources or the one or more aperiodic CLI SRS-RSRP resources that occurs during the CLI measurement time window and transmitting a report including one or more L1 UE to UE CLI measurement values of the set of L1 UE to UE CLI measurement values based on the configuration message. In some examples of the method, UEs, and non-transitory computer-readable medium described herein, the set of L1 UE to UE CLI measurement values includes one or more RSRP values, one or more RSSI values, or a combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports time window-based cross-link interference (CLI) measurement and reporting in accordance with one or more aspects of the present disclosure.

FIG. 2 shows an example of a network architecture that supports time window-based CLI measurement and reporting in accordance with one or more aspects of the present disclosure.

FIG. 3 shows an example of a wireless communications system that supports time window-based CLI measurement and reporting in accordance with one or more aspects of the present disclosure.

FIGS. 4 and 5 show examples of signaling diagrams that support time window-based CLI measurement and reporting in accordance with one or more aspects of the present disclosure.

FIG. 6 shows an example of a process flow that supports time window-based CLI measurement and reporting in accordance with one or more aspects of the present disclosure.

FIGS. 7 and 8 show block diagrams of devices that support time window-based CLI measurement and reporting in accordance with one or more aspects of the present disclosure.

FIG. 9 shows a block diagram of a communications manager that supports time window-based CLI measurement and reporting in accordance with one or more aspects of the present disclosure.

FIG. 10 shows a diagram of a system including a device that supports time window-based CLI measurement and reporting in accordance with one or more aspects of the present disclosure.

FIGS. 11 and 12 show flowcharts illustrating methods that support time window-based CLI measurement and reporting in accordance with one or more aspects of the present disclosure.

### DETAILED DESCRIPTION

Some wireless communications systems may support full-duplex communications, where a single device performs concurrent transmission and reception. In a sub-band full-duplex (SBFD) communication scheme, a communication device may use different portions of a component carrier (CC) bandwidth to perform uplink and downlink communications in the same slot, so as to reduce the likelihood of interference between the uplink and downlink communications. In an in-band full-duplex communication scheme, uplink resources may overlap (partially or fully) with downlink resources.

In some cases, communications at one communication device may cause cross link interference (CLI) at another communication device. For example, uplink communications from a first user equipment (UE) may interfere with a second UE that is attempting to receive downlink communications from a network entity. A UE that interferes with another UE may be known as an aggressor UE (e.g., with respect to the UE whose communications are interfered with). In some examples, multiple UEs may interfere with a UE. CLI may result in lower throughout, decreased communication reliability, higher interference, etc. In some cases, existing channel state information (CSI) reporting techniques may be used to estimate and/or mitigate CLI. For example, in some other wireless communications systems, a UE may receive an aperiodic CSI trigger for the UE to report a channel measurement resource (CMR) with, or without, interference measurement resources (IMRs). However, it may be beneficial (e.g., to differentiate between aggressor UEs) for a UE to report one or more layer one (L1) CLI sounding reference signal received power (SRS-RSRP) resource and/or L1 CLI received signal strength indicator (RSSI) resource measurements.

The techniques described herein may enable a UE to receive a configuration message that may configure a set of CLI resources (CLI-RSSI and/or SRS-RSRP resources), where each CLI resource may be configured with a respective slot offset. Based on receiving a control message, the UE may monitor and report the CLI resources in accordance with their respective slot offsets. Additionally, or alternatively, the UE may receive a control message that triggers a time window for the UE to monitor and measure any CLI resources that occurs within the time window. The UE may report a quantity of measurements (e.g., the N strongest or N weakest) in the time window, which may be associated with a quantity (e.g., the N strongest or N weakest) of aggressor UEs. Different aggressor UEs may transmit in different slots scheduled by the base station. Thus, the UE may measure CLI levels and differentiate between different aggressor UEs via the CLI resources (e.g., CLI-RSSI and/or SRS-RSRP resources).

Aspects of the disclosure are initially described in the context of wireless communications systems and a network architecture. Aspects of the disclosure are further illustrated by and described with reference to signaling diagrams, apparatus diagrams, system diagrams, and flowcharts that relate to time window-based CLI measurement and reporting.

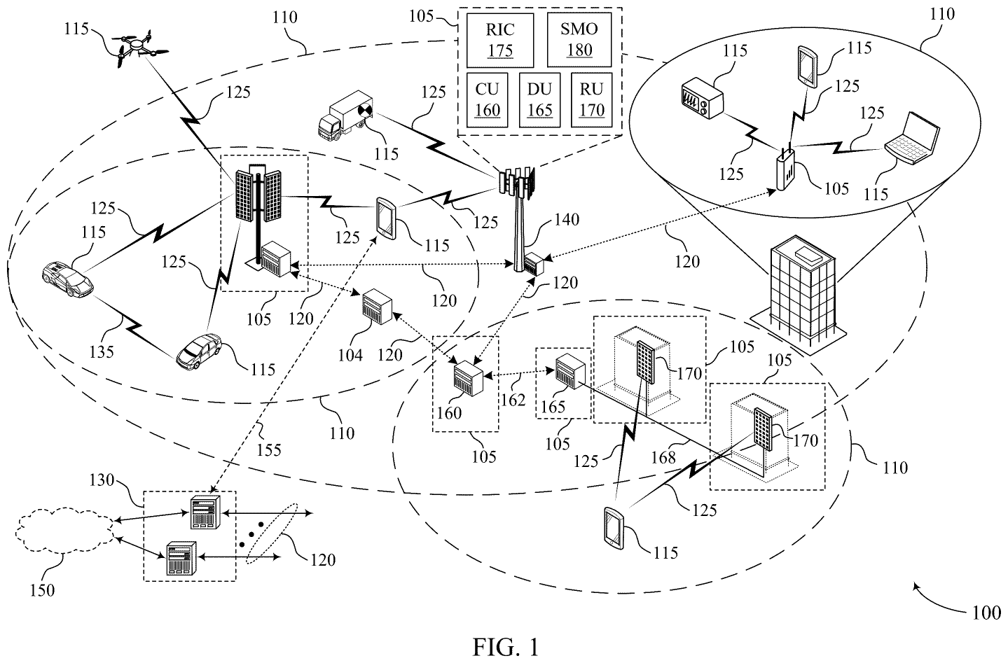

FIG. 1 shows an example of a wireless communications system 100 that supports time window-based CLI measurement and reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, full-duplex communications at one communication device may cause CLI at another communication device. For example, uplink communications from a first UE 115 may interfere with a second UE 115 that is attempting to receive downlink communications from a network entity 105. A UE 115 that interferes with another UE 115 may be known as an aggressor UE 115 (e.g., with respect to the UE 115 whose communications are interfered with). In some examples, multiple UEs 115 may interfere with a UE 115. CLI may result in lower throughout, decreased communication reliability, higher interference, etc. In some cases, existing CSI reporting techniques may be used to estimate and/or mitigate CLI. For example, in some other wireless communications systems, a UE 115 may receive an aperiodic CSI trigger for the UE 115 to report a CMR with, or without, IMRs. However, it may be beneficial (e.g., to differentiate between aggressor UEs 115) for a UE 115 to report one or more L1 CLI SRS-RSRP resource and/or L1 CLI RSSI resource measurements.

The techniques described herein may enable a UE 115 to receive a configuration message that may configure a set of CLI resources (CLI-RSSI and/or SRS-RSRP resources), where each CLI resource may be configured with a respective slot offset. Based on receiving a control message, the UE 115 may monitor and report the CLI resources in accordance with their respective slot offsets. Additionally, or alternatively, the UE 115 may receive a control message that triggers a time window for the UE 115 to monitor and measure any CLI resources that occurs within the time window. The UE 115 may report a quantity of measurements (e.g., the N strongest or N weakest) in the time window, which may be associated with a quantity (e.g., the N strongest or N weakest) of aggressor UEs. Thus, the UE 115 may measure CLI levels and differentiate between different aggressor UEs 115 via the CLI resources (e.g., CLI-RSSI and/or SRS-RSRP resources).

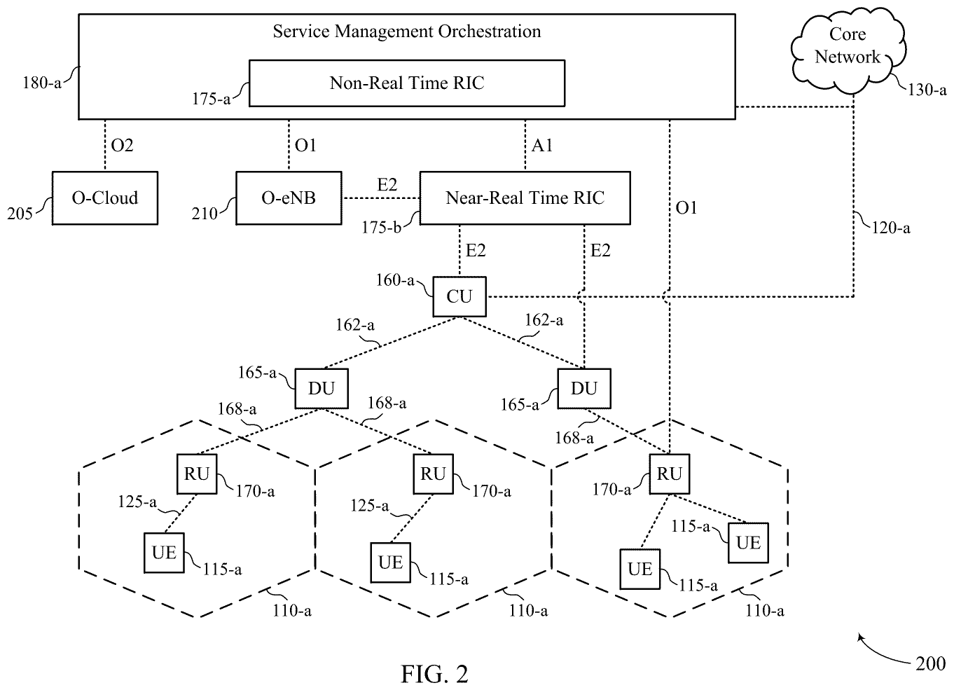

FIG. 2 shows an example of a network architecture 200 (e.g., a disaggregated base station architecture, a disaggregated RAN architecture) that supports time window-based CLI measurement and reporting in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (IFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

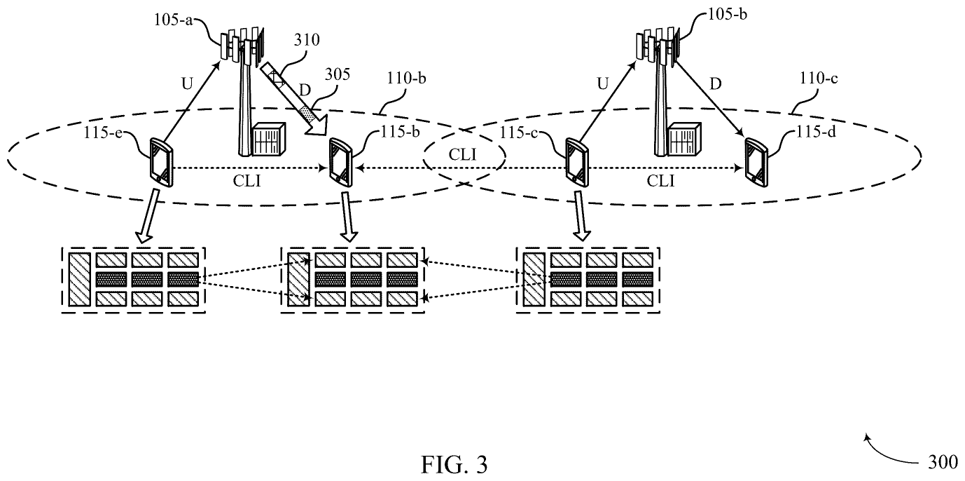

FIG. 3 shows an example of a wireless communications system 300 that supports time window-based CLI measurement and reporting in accordance with one or more aspects of the present disclosure. The wireless communications system 300 may implement or be implemented by aspects of the wireless communications system 100 or the network architecture 200, as described with reference to FIGS. 1 and 2. For example, the wireless communications system 300 includes a UE 115-b, a UE 115-c, a UE 115-d, UE 115-c, a network entity 105-a, and a network entity 105-b, which may be examples of corresponding devices described herein, including with reference to FIGS. 1 and 2. The network entity 105-a and the network entity 105-b may communicate with the UEs 115 within a first coverage area 110-b (e.g., corresponding to network entity 105-a) and/or within a second coverage area 110-c (e.g., corresponding to network entity 105-b), which may be examples of the coverage areas 110 described with reference to FIGS. 1 and 2. The wireless communications system 300 illustrates various examples of CLI that may result from full-duplex communications between the UEs 115 and the network entities 105.

As described herein, the wireless communications system 300 may support full-duplex communications, where a single device (such as the network entity 105-a or the network entity 105-b) may perform concurrent transmission and reception. In a SBFD communication scheme, a communication device may use different portions of a CC bandwidth to perform uplink and downlink communications in a same transmission time interval (TTI), such as a slot, which may reduce the likelihood of interference between the uplink and downlink communications.

In some cases, full-duplex communications from one communication device may cause interference. For example, if the network entity 105-a transmits a downlink message to the UE 115-b while attempting to receive an uplink message from the UE 115-e, transmission of the downlink message may interfere with reception of the uplink message. Full-duplex communications (e.g., or any other type of outgoing transmission) may cause CLI at other communication devices. For example, uplink communications from the UE 115-c may interfere with the reception of downlink communications at the UE 115-b. CLI may result in lower throughput, decreased communication reliability, higher interference, etc.

In SBFD deployments, uplink communications from the UE 115-e may cause inter-sub band intra-cell CLI at the UE 115-b, and uplink communications from the UE 115-c may cause inter-sub-band inter-cell inter-UE CLI at the UE 115-b. In partial or fully overlapped full-duplex scenarios, uplink communications from the UE 115-e may cause in in-band intra-cell inter-UE CLI at the UE 115-b, and uplink communications from the UE 115-c may cause in-band inter-cell inter-UE CLI at the UE 115-b. A UE 115 that causes CLI at another UE 115 may be known as an “aggressor” UE. In some cases, CSI reporting techniques may be used to estimate and/or mitigate CLI.

The wireless communications system 300 may support SBFD in a TDD carrier or intra-band CA based communication scheme. As described herein, SBFD refers to a full-duplex communication scheme in which downlink resources and uplink resources occupy different portions of a CC bandwidth for a given slot. In other words, SBFD may refer to simultaneous transmission and reception of downlink and uplink communications on a sub-band basis. In the example of FIG. 3, the network entity 105-a and the network entity 105-b may be examples of full-duplex gNBs that support simultaneous transmission and reception in the same slot.

SBFD communication schemes may support uplink duty cycle increases, thereby promoting reduced latency and improved uplink coverage. For example, in an SBFD communication scheme, communication devices may transmit uplink signals in an uplink sub-band in downlink or flexible slots, or receive downlink signals in downlink sub-ban(s) in legacy uplink slots, which may provide latency savings. SBFD communication schemes may also provide uplink coverage improvements, system capacity enhancements, resource utilization improvements, and greater spectral efficiency. Further, SBFD communications may support flexible and dynamic uplink/downlink resource adaption according to uplink/downlink traffic in a robust manner.

Aspects of the present disclosure support techniques for L1 based UE-to-UE CLI measurement and reporting for dynamic TDD scenarios, such as sub-band non-overlapping full-duplex communications, partially-overlapping full-duplex communications, fully-overlapping full-duplex communications, or a combination thereof. SRS-RSRP and CLI-RSSI may be used as baseline metrics for L1 based UE-to-UE CLI measurements. For L1 based UE-to-UE CLI measurement and reporting, a CSI framework may be used, but other frameworks are not precluded. In some other wireless communications systems, a UE 115 may receive an aperiodic CSI trigger for the UE 115 to report a CMR with, or without, IMRs. However, it may be beneficial (e.g., to differentiate between aggressor UEs 115) for a UE 115 to report one or more L1 SRS-RSRP and/or L1 CLI-RSSI resource measurements.

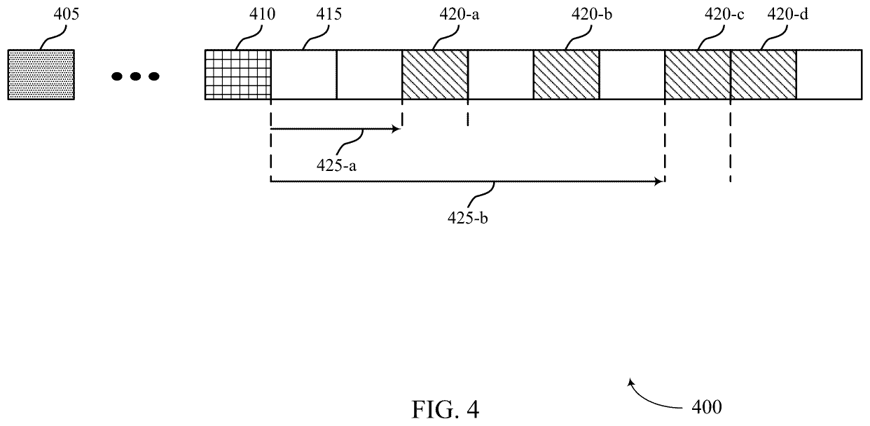

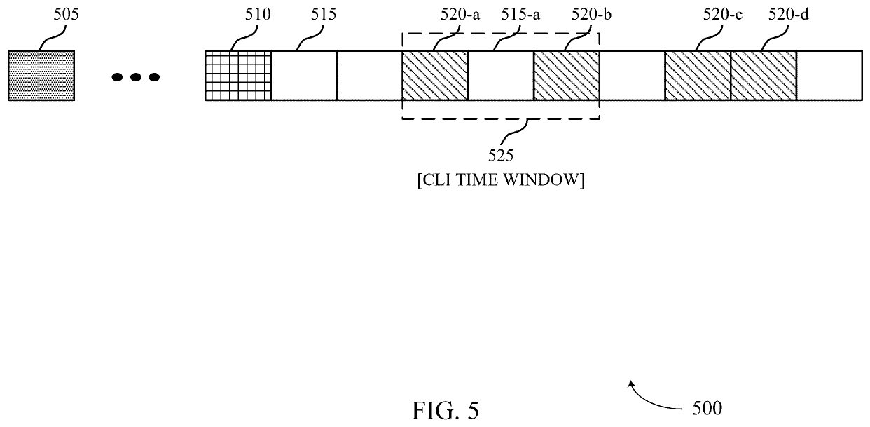

As described herein, a UE 115 may receive a configuration message 305 that may configure a set of CLI resources (CLI-RSSI and/or SRS-RSRP resources), where each CLI resource may be configured with a respective slot offset. Based on receiving a control message 310 (e.g., a downlink control information (DCI) message), the UE 115 may monitor and report the CLI resources in accordance with their respective slot offsets, as described further with reference to FIG. 4. In some examples, the configuration message 305 may configure a set of CLI resources, where each CLI resources may be configured in a different slot. In such examples, the control message 310 may trigger the set of CLI resources that contains multiple CLI resources with different slots for the UE 115 to measure. Additionally, or alternatively, the control message 310 may trigger a time window that includes one or more CLI resources for the UE 115 to measure. For example, the control message 310 may indicate one or more CLI-RSSI resources configured per slot in the time window. The UE 115 may report a quantity of measurements (e.g., the N strongest or N weakest) in the time window, which may be associated with a quantity (e.g., the N strongest or N weakest) of aggressor UEs 115, as described with reference to FIG. 5. Thus, the UE 115 may measure CLI levels and differentiate between different aggressor UEs via the CLI resources (e.g., CLI-RSSI). For example, the UE 115-b may report the quantity of measurements in the time window (e.g., and/or in accordance with respective CLI resource slot offsets) and differentiate interference between the UE 115-e and the UE 115-c.

FIG. 4 shows an example of a signaling diagram 400 that supports time window-based CLI measurement and reporting in accordance with one or more aspects of the present disclosure. The signaling diagram 400 may implement or be implemented by aspects of the wireless communications systems 100 and 300 or the network architecture 200, as described with reference to FIGS. 1 through 3. For example, the signaling diagram 400 includes a configuration message 405 and a control message 410, which may examples of the configuration message 305 and the control message 310 described with reference to FIG. 3. In the signaling diagram 400, a UE (such as the UE 115-b described with reference to FIG. 3) may receive the configuration message 405 that indicates an aperiodic offset (e.g., aperiodicTriggeringOffset-r19) per CLI resource, such as an SRS-RSRP resource or CLI-RSSI resource.

In some other wireless communication systems, a UE may receive a CSI-RS resource set (e.g., a non-zero power (NZP) CSI-RS resource set) that may configure an offset (e.g., aperiodicTriggeringOffset) per resource set. The offset may be a duration offset between a first TTI (e.g., a slot) that includes a DCI message that triggers a set of one or more aperiodic resources (such as NZP CSI-RS resources) and a second TTI in which the resources are transmitted. That is, the offset may indicate a duration between a DCI message and a set of resources. For example, an offset value of zero may correspond to zero TTIs between the DCI message and the resources (e.g., the resources may occur within the same slot as the DCI message), an offset value of one may correspond to one TTI (e.g., the resources are in a slot adjacent to the slot including the DCI message), the offset value of two may correspond to two TTIs, an offset value of three may correspond to three TTIs, an offset value of four may correspond to four TTIs, an offset value of five may correspond to sixteen TTIs, and an offset value of six may correspond to twenty-four TTIs.

The techniques described herein may enable the UE to receive the configuration message 405, which may configure an offset value 425 (e.g., aperiodicTriggeringOffset-r19) per CLI resource, such as per SRS-RSRP resource or CLI-RSSI resource. That is, each CLI resource in a resource set may be configured with a respective offset value 425 (e.g., a respective TTI/slot offset). For example, an offset value 425 of zero for a first CLI resource may correspond to zero TTIs, an offset value 425 of one for a second CLI resource may correspond to one TTI, an offset value 425 two for a third CLI resource may correspond to two TTIs, an offset value 425-a of three for a fourth CLI resource may correspond to three TTIs (e.g., from the control message 410), and an offset value 425 of four for a fifth CLI resource may correspond to four TTIs in a CLI resource set (e.g., a CLI resource set triggered by the control message 410). In some examples, the UE may receive the configuration message 405 based on a capability of the UE to support the offset value 425. For example, the UE may transmit a capability message indicating the capability of the UE to support the offset value 425, and the UE may receive the configuration message 405 based on transmitting the capability message.

In some examples, the configuration message 405 may include a parameter (e.g., nrofReportedRS) that may configure a quantity of reported reference signals. In some cases, the parameter may be based on (e.g., under) a second parameter (e.g., groupBasedBeamReporting) associated with reporting reference signal measurements. In such examples, a network entity may configure the UE to report a quantity (e.g., one to four, or, in some cases, more than four) of CLI resources associated with different UEs, receive beams, transmit beams, or a combination thereof.

The UE may receive the control message 410 (e.g., a DCI trigger), which may trigger the UE to measure one or more CLI resources in accordance with their respective slot offsets. In some cases, the UE may receive the control message 410 a duration after (and/or concurrent with) the configuration message 405. The control message 410 may indicate for the UE to perform a L1 UE-to-UE CLI measurement on one or more CLI-RSSI resources and/or one or more CLI SRS-RSRP resources. That is, the UE may measure one or more CLI resources in an n+Y slot, where n corresponds to the slot including the control message 410 and Y corresponds to the offset value 425 of a respective CLI resource indicated in the configuration message 405. For example, the UE may receive the control message 410 in a first slot, and the control message 410 may indicate an offset value 425-a of three. Based on the offset value 425-a, the UE may measure CLI resource 420-a three slots after the first slot. The UE may not measure other resources 415 (e.g., non-CLI resources) and/or CLI resources 420 not indicated by the control message 410. For example, the UE may not measure CLI resource 420-b or CLI resource 420-d.

In some examples, the UE may measure up to n+Y+L, where L corresponds to a last CLI resource in a triggered CLI resource set (e.g., a CLI resource set triggered by the control message 410). For example, the control message 410 may trigger a CLI resource set including the CLI resource 420-a and the CLI resource 420-c (e.g., the control message 410 may include an offset value 425 for each of the CLI resources 420-a and 420-c). That is, the UE may measure CLI resource 420-c six slots after the first slot in accordance with an offset value 425-b of six.

In addition to the respective offset values 425, the control message 410 may include a parameter indicating a quantity of, and/or which, symbols per slot for the UE to measure the CLI resources (e.g., the CLI-RSSI resources or the CLI SRS-RSRP resources). In some examples, the parameter may indicate the quantity and which symbols via a bitmap or an indication of symbol number(s) per slot. For example, the second symbol of first and second slots to measure CLI-RSSI may be indicated via a bitmap of 0100000000000001000000000000, where a ‘1’ may indicate which respective symbol to measure (e.g., if the indication is per slot, the bitmap may be 14 bits long, if the indication is for every two slots, the bitmap may be 28 bits long). Additionally, or alternatively, the control message 410 may include a parameter indicating a frequency location. For example, the frequency location indication may indicate the UE to measure within a wideband downlink BWP or within one or more downlink sub-bands. In some examples, the CLI resource measurements per TTI may be different for different UEs, different receive beams, different transmit beams, or any combination thereof, based on a configuration by the network entity (e.g., based on the configuration message 405).

In some examples, the UE may ignore an offset value at a resource set level (e.g., ignore the aperiodicTriggeringOffset). That is, the UE may ignore an offset value configured for a duration between a control message and a slot in which a resource set is transmitted. In such examples, the UE may measure different CLI resources in different TTIs (e.g., in different time slots) in accordance with respective offset values 425 for each of the CLI resources. The network entity may ensure (e.g., via configuration and/or requirement) that the triggered CLI resources in a resource set are within a time window intended for the CLI measurement. For example, the network entity may transmit the triggered CLI resources within the time window. Additionally, or alternatively, the network entity may transmit the control message 410 with offset values 425 such that the triggered CLI resources are within the time window.

FIG. 5 shows an example of a signaling diagram 500 that supports time window-based CLI measurement and reporting in accordance with one or more aspects of the present disclosure. The signaling diagram 500 may implement or be implemented by aspects of the wireless communications systems 100 and 300 or the network architecture 200, as described with reference to FIGS. 1 through 3. For example, the signaling diagram 500 includes a configuration message 505 and a control message 510, which may be examples of the configuration message 305 and the control message 310 described with reference to FIG. 3. In the signaling diagram 500, a UE (such as the UE 115-b described with reference to FIG. 3) may receive the configuration message 505 that may indicate (e.g., via a CSI-ReportConfig parameter) the UE to monitor and measure one or more CLI resources within a time window.

As described herein, the UE may receive the configuration message 505, which may configure a time window 525. That is, the configuration message 505 may indicate one or more time and/or frequency resources that define the time window 525 for CLI measurement and/or aperiodic CLI reporting. In some examples, the UE may receive the configuration message 505 based on a capability of the UE to support the time window 525. For example, the UE may transmit a capability message indicating the capability of the UE to support the time window 525, and the UE may receive the configuration message 505 based on transmitting the capability message. In some examples, the UE may ignore configured resources (e.g., previously configured resources) in a report configuration based on receiving the configuration message 505. Additionally, or alternatively, a network entity may not configure resources in the report configuration (e.g., in CSI-ReportConfig).

In some examples, the configuration message 505 may include a parameter (e.g., nrofReportedRS) that may configure a quantity of reported reference signals. In some cases, the parameter may be under a second parameter (e.g., groupBasedBeamReporting) associated with reporting reference signal measurements. In such examples, a network entity may configure the UE to report a quantity (e.g., one to four, or, in some cases, more than four) of CLI resources associated with different UEs, receive beams, transmit beams, or a combination thereof.

In some examples, the UE may receive the control message 510 (e.g., a DCI trigger), which may trigger the UE to monitor and measure one or more CLI resources within the time window and within the configured time and/or frequency resources. In some cases, the UE may receive the control message 510 a duration after (and/or concurrent with) the configuration message 505. The control message 510 may indicate for the UE to monitor one or more frequency resources for a duration corresponding to the time window 525 (e.g., for a quantity of TTIs/slots). For example, the UE may monitor the CLI resource 520-a, resource 515-a (e.g., a non-CLI resource), and the CLI resource 520-b in accordance with the time window 525. The UE may measure (e.g., and subsequently report) the CLI resource 520-a and the CLI resource 520-b based on the CLI resources occurring during the time window 525. (the UE may not measure or report on the resources 515 based on the resources 515 not being CLI resources 520). The UE may not measure the CLI resource 520-c or the CLI resource 520-d because those CLI resources occur outside the time window 525.

In some examples, the control message 510 may include a parameter indicating a window of time slots which includes a slot offset to a starting slot of the time window 525 (e.g., an offset from the control message 510) and a duration (e.g., length) of the time window 525. That is, after N slots from the control message 510 is the start of the window and the window length is M slots. For example, FIG. 5 illustrates a time window 525 with an offset value of three slots from the control message 510 and a length of three slots. The control message 510 may also include a parameter indicating a quantity of, and/or which, symbols per slot for the UE to measure the CLI resources (e.g., the CLI-RSSI resources or the CLI SRS-RSRP resources). In some examples, the parameter may indicate the quantity and/or which symbols via a bitmap or an indication of symbol number(s) per slot. For example, the second symbol of first and second slots to measure CLI-RSSI are indicated via a bitmap of 0100000000000001000000000000. Additionally, or alternatively, the control message 510 may include a parameter indicating a frequency location. For example, the frequency location indication may indicate the UE to measure within a wideband downlink BWP or within one or more downlink sub-bands. In some examples, the CLI resource measurements per TTI may be different for different UEs, different receive beams, different transmit beams, or any combination thereof, based on a configuration by the network entity (e.g., based on the configuration message 505).

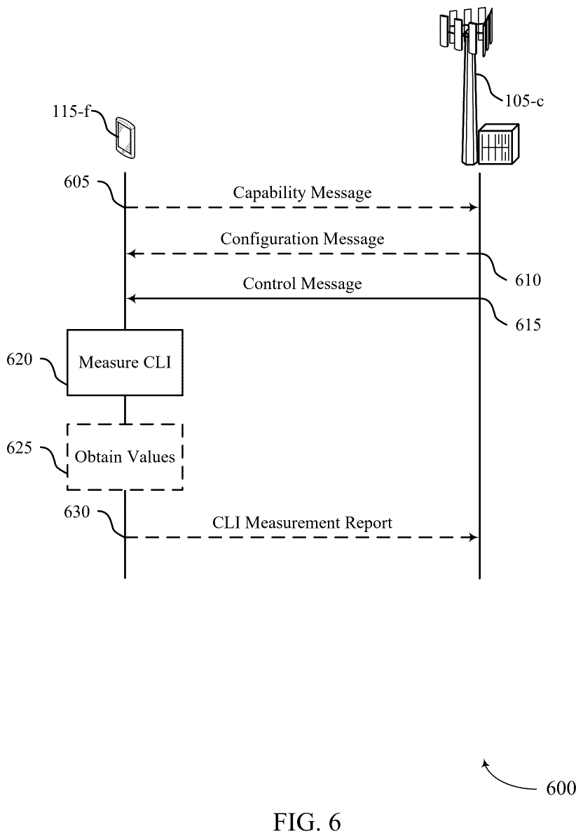

FIG. 6 shows an example of a process flow 600 that supports time window-based CLI measurement and reporting in accordance with one or more aspects of the present disclosure. The process flow may implement or be implemented by aspects of any of the wireless communications systems, network architecture, or signaling diagrams described with reference to FIGS. 1 through 5. For example, the process flow 600 includes a network entity 105-c and a UE 115-f, which may be examples of corresponding devices described herein, including with reference to FIGS. 1 and 2. In the following description of the process flow 600, operations between the network entity 105-c and the UE 115-f may be added, omitted, or performed in a different order (with respect to the exemplary order shown).

At 605, the UE 115-f may transmit a capability message indicating a capability of the UE 115-f to support a L1 UE to UE CLI measurement on one or more aperiodic CLI-RSSI resources or the one or more aperiodic CLI SRS-RSRP resources during the CLI measurement time window.

At 610, the UE 115-f may receive a configuration message that indicates a set of CLI-RSSI resources or a set of CLI SRS-RSRP resources. In some examples, the configuration message may indicate a respective resource level offset for each respective CLI-RSSI resource set of CLI-RSSI resources or each respective CLI SRS-RSRP resource of the set of CLI SRS-RSRP resources, as described further with reference to FIG. 4. The UE 115-f may perform the L1 UE to UE CLI measurement on the one or more aperiodic CLI SRS-RSRP resources and during each respective slot associated with the one or more aperiodic CLI-RSSI resources or the one or more aperiodic CLI SRS-RSRP resources according to the respective resource level slot offset for each of the one or more aperiodic CLI-RSSI resources or the one or more aperiodic CLI SRS-RSRP resources. In some examples, the configuration message may indicate a quantity of CLI-RSSI resources or CLI SRS-RSRP resources for reporting L1 UE to UE CLI measurement. Additionally, or alternatively, the configuration message may indicate a time window for a L1 UE to UE CLI measurement, where the configuration message indicates one or more time and frequency locations associated with the CLI measurement time window, as described further with reference to FIG. 5.

At 615, the UE 115-f may receive a control message that may trigger one or more aperiodic CLI-RSSI resources, one or more aperiodic CLI-RSRP resources, or a CLI measurement time window, for a L1 UE to UE CLI measurement. The control message may be based on the capability message. In some examples, the CLI measurement time window may correspond to one or more time and frequency locations. For example, the control message may be associated with a CLI measurement time window associated with the one or more aperiodic CLI-RSSI resources or the one or more aperiodic CLI SRS-RSRP resources for the L1 UE to UE CLI measurement. In some examples, the control message may indicate a time duration between an ending slot associated with the control message and a beginning slot associated with the CLI measurement time window, as described with reference to FIG. 5. The control message may further indicate a length of the CLI measurement time window. In some examples, receiving the control message may trigger the CLI measurement time window for the L1 UE to UE CLI measurement.

Additionally, or alternatively, the control message may indicate a quantity of symbols per slot to monitor and measure associated with the one or more aperiodic CLI-RSSI resources or the one or more aperiodic CLI SRS-RSRP resources, where the quantity of symbols per slot are indicated via a bitmap or an indication of one or more symbol numbers. In some examples, the control message may indicate a quantity of sub bands or bands to monitor and measure associated with the one or more aperiodic CLI-RSSI resources or the one or more aperiodic CLI SRS-RSRP resources for the L1 UE to UE CLI measurement.

At 620, the UE 115-f may perform the L1 UE to UE CLI measurement on the one or more CLI-RSSI resources, the one or more aperiodic CLI SRS-RSRP resources, or during the CLI measurement time window. For example, the UE 115-f may perform the L1 UE to UE CLI measurement on the one or more aperiodic CLI-RSSI resources or the one or more aperiodic CLI SRS-RSRP resources during the CLI measurement time window. In some examples, each respective slot (e.g., TTI) associated with the one or more aperiodic CLI-RSSI resources or the one or more aperiodic CLI SRS-RSRP resources may occur during the CLI measurement time window.

Additionally, or alternatively, the UE 115-f may identify a respective resource set level slot offset for the set of CLI-RSSI resources or the set of CLI SRS-RSRP resources, where the respective resource level slot offset may be applicable for the set of CLI-RSSI resources or the set of CLI SRS-RSRP resources. The UE 115-f may bypass (e.g., ignore) a usage of the respective resource set level slot offset for the set of CLI-RSSI resources or the set of CLI SRS-RSRP resources based on the respective resource level slot offset for each respective CLI-RSSI resource of the set of CLI-RSSI resources or for each respective CLI SRS-RSRP resource of the set of CLI SRS-RSRP resources. In some examples, the UE 115-f may perform the L1 UE to UE CLI measurement on the one or more aperiodic CLI-RSSI resources or the one or more aperiodic CLI SRS-RSRP resources based on bypassing the usage of the respective resource set level slot offset. In some examples, the L1 UE to UE CLI measurement performed on the one or more aperiodic CLI-RSSI resources or the one or more aperiodic CLI SRS-RSRP resources may be associated with multiple neighbor UEs, multiple receive beams, multiple transmit beams, or a combination thereof.

At 625, the UE 115-f may obtain a set of L1 UE to UE CLI measurement values based on the L1 UE to UE CLI measurement performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources that occurs during the CLI measurement time window. In some examples, the set of L1 UE to UE CLI measurement values may include one or more RSRP values, one or more RSSI values, or a combination thereof. Additionally, or alternatively, the one or more L1 UE to UE CLI measurement values may satisfy a threshold L1 UE to UE CLI measurement value.

At 630, the UE 115-f may transmit a report including one or more L1 UE to UE CLI measurement values of the set of L1 UE to UE CLI measurement values based on the configuration message. The UE 115-f may transmit the report based on the quantity of CLI-RSSI resources or CLI SRS-RSRP resources indicated in the configuration message. In some examples, one or more reporting criterion associated with the report may be based on a quantity of most interfering or least interfering CLI-RSSI resources or CLI SRS-RSRP resources. In such examples, the most interfering or least interfering CLI-RSSI resources or CLI SRS-RSRP resources may be associated with the strongest or weakest aggressor UEs with respect to the UE 115-f.

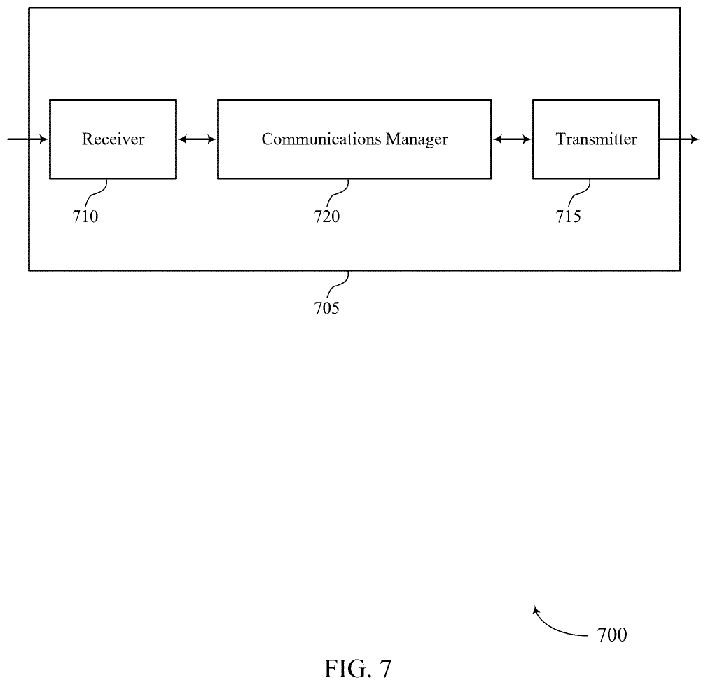

FIG. 7 shows a block diagram 700 of a device 705 that supports time window-based CLI measurement and reporting in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to time window-based CLI measurement and reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to time window-based CLI measurement and reporting). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of time window-based CLI measurement and reporting as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations. The communications manager 720 is capable of, configured to, or operable to support a means for performing the L1 UE to UE CLI measurement on the one or more aperiodic CLI-RSSI resources, the one or more aperiodic CLI SRS-RSRP resources, or during the CLI measurement time window.

Additionally, or alternatively, the communications manager 720 may support wireless communication in accordance with examples as disclosed herein. For example, the communications manager 720 is capable of, configured to, or operable to support a means for receiving a configuration message that indicates a time window for an L1 UE to UE CLI measurement, where the configuration message indicates one or more time and frequency locations associated with the CLI measurement time window. In some examples, the communications manager 720 is capable of, configured to, or operable to support a means for receiving a configuration message that indicates a set of CLI-RSSI resources or a set of CLI SRS-RSRP resources, the set of CLI-RSSI resources or the set of CLI SRS-RSRP resources comprising a plurality of CLI-RSSI resources or CLI SRS-RSRP resources, respectively, wherein the configuration message indicates a different slot for each CLI-RSSI resource of the plurality of CLI-RSSI resources or each CLI SRS-RSRP resource of the plurality of CLI SRS-RSRP resources. The communications manager 720 is capable of, configured to, or operable to support a means for receiving a control message that triggers the CLI measurement time window for the L1 UE to UE CLI measurement. The communications manager 720 is capable of, configured to, or operable to support a means for performing the L1 UE to UE CLI measurement during the CLI measurement time window.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, and more efficient utilization of communication resources, among other examples.

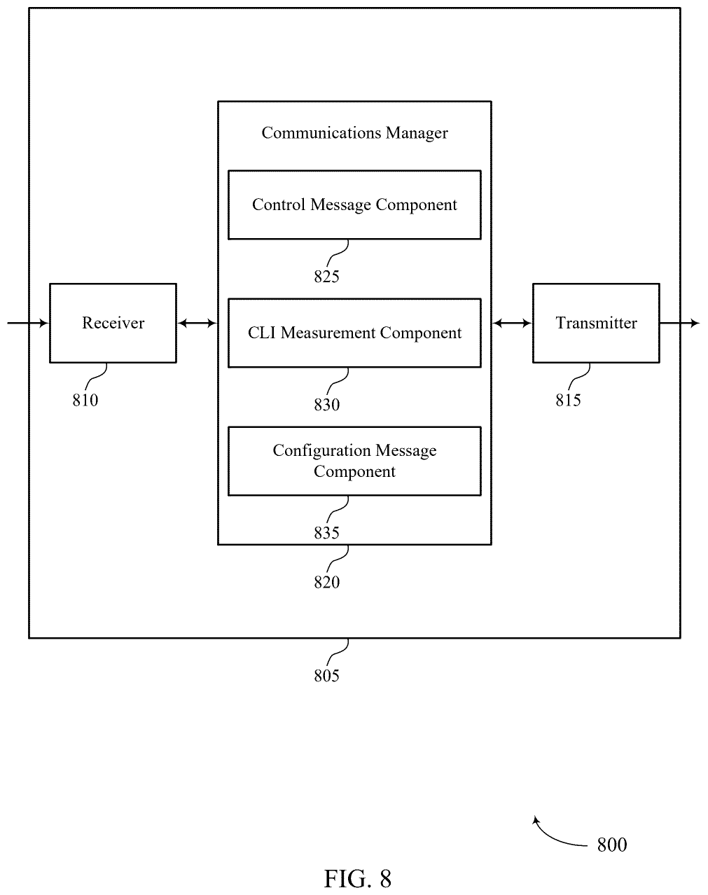

FIG. 8 shows a block diagram 800 of a device 805 that supports time window-based CLI measurement and reporting in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to time window-based CLI measurement and reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to time window-based CLI measurement and reporting). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of time window-based CLI measurement and reporting as described herein. For example, the communications manager 820 may include a control message component 825, a CLI measurement component 830, a configuration message component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The control message component 825 is capable of, configured to, or operable to support a means for receiving a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations. The CLI measurement component 830 is capable of, configured to, or operable to support a means for performing the L1 UE to UE CLI measurement on the one or more aperiodic CLI-RSSI resources, the one or more aperiodic CLI SRS-RSRP resources, or during the CLI measurement time window.

Additionally, or alternatively, the communications manager 820 may support wireless communication in accordance with examples as disclosed herein. The configuration message component 835 is capable of, configured to, or operable to support a means for receiving a configuration message that indicates a time window for an L1 UE to UE CLI measurement, where the configuration message indicates one or more time and frequency locations associated with the CLI measurement time window. In some examples, the configuration message component 835 is capable of, configured to, or operable to support a means for receiving a configuration message that indicates a set of CLI-RSSI resources or a set of CLI SRS-RSRP resources, the set of CLI-RSSI resources or the set of CLI SRS-RSRP resources comprising a plurality of CLI-RSSI resources or CLI SRS-RSRP resources, respectively, wherein the configuration message indicates a different slot for each CLI-RSSI resource of the plurality of CLI-RSSI resources or each CLI SRS-RSRP resource of the plurality of CLI SRS-RSRP resources. The control message component 825 is capable of, configured to, or operable to support a means for receiving a control message that triggers the CLI measurement time window for the L1 UE to UE CLI measurement. The CLI measurement component 830 is capable of, configured to, or operable to support a means for performing the L1 UE to UE CLI measurement during the CLI measurement time window.

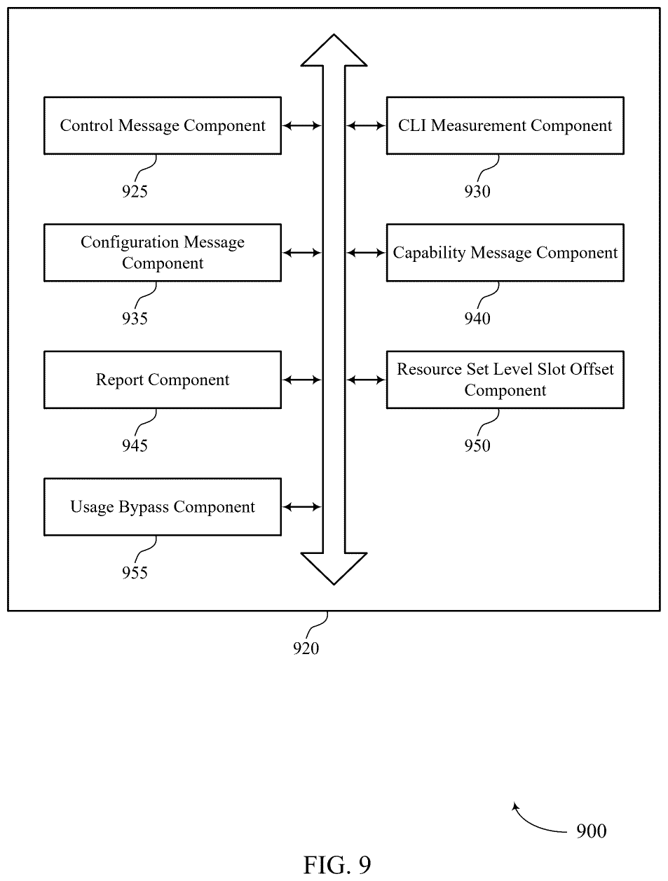

FIG. 9 shows a block diagram 900 of a communications manager 920 that supports time window-based CLI measurement and reporting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of time window-based CLI measurement and reporting as described herein. For example, the communications manager 920 may include a control message component 925, a CLI measurement component 930, a configuration message component 935, a capability message component 940, a report component 945, a resource set level slot offset component 950, a usage bypass component 955, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The control message component 925 is capable of, configured to, or operable to support a means for receiving a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations. The CLI measurement component 930 is capable of, configured to, or operable to support a means for performing the L1 UE to UE CLI measurement on the one or more aperiodic CLI-RSSI resources, the one or more aperiodic CLI SRS-RSRP resources, or during the CLI measurement time window.

In some examples, the configuration message component 935 is capable of, configured to, or operable to support a means for receiving a configuration message that indicates a set of CLI-RSSI resources or a set of CLI SRS-RSRP resources, and where the configuration message indicates a respective resource level slot offset for each respective CLI-RSSI resource of the set of CLI-RSSI resources or for each respective CLI SRS-RSRP resource of the set of CLI SRS-RSRP resources, where the L1 UE to UE CLI measurement is performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources according to the respective resource level slot offset for each of one or more aperiodic CLI-RSSI resources or the one or more aperiodic CLI SRS-RSRP resources.

In some examples, the configuration message component 935 is capable of, configured to, or operable to support a means for receiving a configuration message that indicates a set of CLI-RSSI resources or a set of CLI SRS-RSRP resources, the set of CLI-RSSI resources or the set of CLI SRS-RSRP resources comprising a plurality of CLI-RSSI resources or CLI SRS-RSRP resources, respectively, wherein the configuration message indicates a different slot for each CLI-RSSI resource of the plurality of CLI-RSSI resources or each CLI SRS-RSRP resource of the plurality of CLI SRS-RSRP resources.

In some examples, the control message is associated with a CLI measurement time window associated with the one or more aperiodic CLI-RSSI resources or the one or more aperiodic CLI SRS-RSRP resources for the L1 UE to UE CLI measurement. In some examples, the L1 UE to UE CLI measurement is performed on the one or more aperiodic CLI-RSSI resources or the one or more aperiodic CLI SRS-RSRP resources during the CLI measurement time window. In some examples, each respective slot associated with the one or more aperiodic CLI-RSSI resources or the one or more aperiodic CLI SRS-RSRP resources occurs during the CLI measurement time window.

In some examples, the CLI measurement component 930 is capable of, configured to, or operable to support a means for obtaining a set of L1 UE to UE CLI measurement values based on the L1 UE to UE CLI measurement performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources that occurs during the CLI measurement time window. In some examples, the report component 945 is capable of, configured to, or operable to support a means for transmitting a report including one or more L1 UE to UE CLI measurement values of the set of L1 UE to UE CLI measurement values based on the configuration message. In some examples, the set of L1 UE to UE CLI measurement values includes one or more RSRP values, one or more RSSI values, or a combination thereof. In some examples, the one or more L1 UE to UE CLI measurement values satisfy a threshold L1 UE to UE CLI measurement value.

In some examples, the configuration message indicates a quantity of CLI-RSSI resources or CLI SRS-RSRP resources for reporting L1 UE to UE CLI measurement. In some examples, the report is transmitted based on the quantity of CLI-RSSI resources or CLI SRS-RSRP resources indicated in the configuration message. In some examples, one or more reporting criterion associated with the report is based on a quantity of most interfering or least interfering CLI-RSSI resources or CLI SRS-RSRP resources.

In some examples, the resource set level slot offset component 950 is capable of, configured to, or operable to support a means for identifying a respective resource set level slot offset for the set of CLI-RSSI resources or the set of CLI SRS-RSRP resources, where the respective resource level slot offset is applicable for the set of CLI-RSSI resources or the set of CLI SRS-RSRP resources. In some examples, the usage bypass component 955 is capable of, configured to, or operable to support a means for bypassing a usage of the respective resource set level slot offset for the set of CLI-RSSI resources or the set of CLI SRS-RSRP resources based on the respective resource level slot offset for each respective CLI-RSSI resource of the set of CLI-RSSI resources or for each respective CLI SRS-RSRP resource of the set of CLI SRS-RSRP resources, where the L1 UE to UE CLI measurement is performed on the one or more aperiodic CLI-RSSI resources or the one or more aperiodic CLI SRS-RSRP resources based on the bypassing.

In some examples, the control message indicates a time duration between an ending slot associated with the control message and a beginning slot associated with the CLI measurement time window. In some examples, the control message indicates a length of the CLI measurement time window. In some examples, the control message indicates a quantity of symbols per slot to monitor and measure associated with the one or more aperiodic CLI-RSSI resources or the one or more aperiodic CLI SRS-RSRP resources, where the quantity of symbols per slot are indicated via a bitmap or an indication of one or more symbol numbers. In some examples, the control message indicates a quantity of sub bands or bands to monitor and measure associated with the one or more aperiodic CLI-RSSI resources or the one or more aperiodic CLI SRS-RSRP resources for the L1 UE to UE CLI measurement. In some examples, the L1 UE to UE CLI measurement performed on the one or more aperiodic CLI-RSSI resources or the one or more aperiodic CLI SRS-RSRP resources is associated with a set of multiple neighbor UEs, a set of multiple receive beams, a set of multiple transmit beams, or a combination thereof.

In some examples, the capability message component 940 is capable of, configured to, or operable to support a means for transmitting a capability message indicating a capability of the UE to support the L1 UE to UE CLI measurement on the one or more aperiodic CLI-RSSI resources or the one or more aperiodic CLI SRS-RSRP resources during the CLI measurement time window, where the control message is based on the capability message.

Additionally, or alternatively, the communications manager 920 may support wireless communication in accordance with examples as disclosed herein. The configuration message component 935 is capable of, configured to, or operable to support a means for receiving a configuration message that indicates a time window for an L1 UE to UE CLI measurement, where the configuration message indicates one or more time and frequency locations associated with the CLI measurement time window. In some examples, the control message component 925 is capable of, configured to, or operable to support a means for receiving a control message that triggers the CLI measurement time window for the L1 UE to UE CLI measurement. In some examples, the CLI measurement component 930 is capable of, configured to, or operable to support a means for performing the L1 UE to UE CLI measurement during the CLI measurement time window.

In some examples, the CLI measurement component 930 is capable of, configured to, or operable to support a means for obtaining a set of L1 UE to UE CLI measurement values based on the L1 UE to UE CLI measurement performed on one or more aperiodic CLI-RSSI resources or one or more aperiodic CLI SRS-RSRP resources and during each respective slot associated with the one or more aperiodic CLI-RSSI resources or the one or more aperiodic CLI SRS-RSRP resources that occurs during the CLI measurement time window. In some examples, the report component 945 is capable of, configured to, or operable to support a means for transmitting a report including one or more L1 UE to UE CLI measurement values of the set of L1 UE to UE CLI measurement values based on the configuration message. In some examples, the set of L1 UE to UE CLI measurement values includes one or more RSRP values, one or more RSSI values, or a combination thereof.

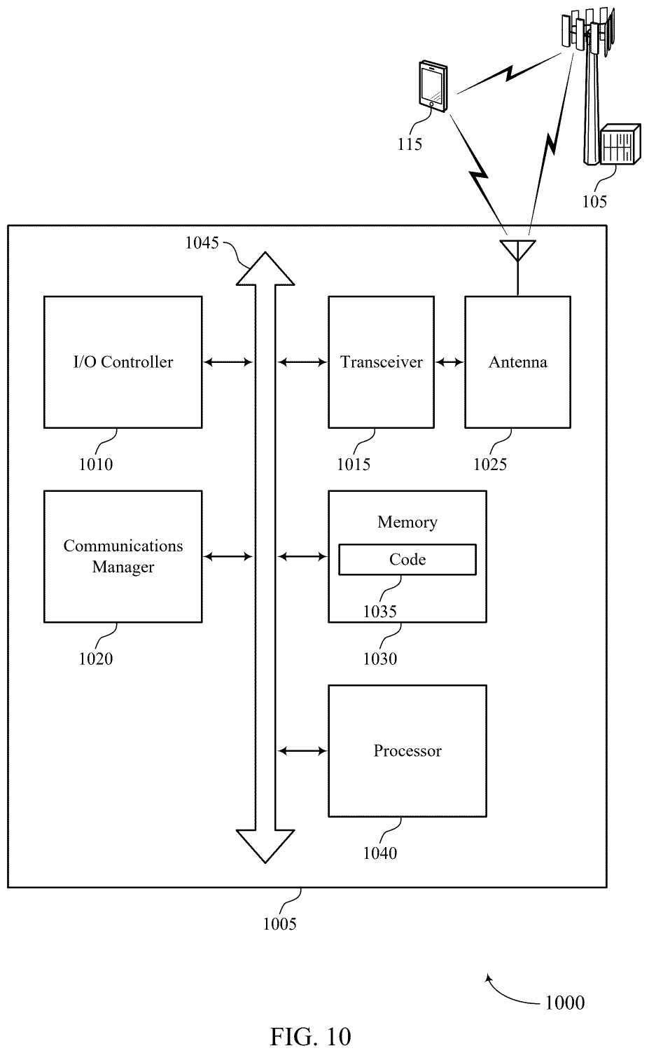

FIG. 10 shows a diagram of a system 1000 including a device 1005 that supports time window-based CLI measurement and reporting in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting time window-based CLI measurement and reporting). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving a control message that triggers one or more aperiodic CLI-RSSI resources, one or more aperiodic CLI SRS-RSRP resources, or a CLI measurement time window, for an L1 UE to UE CLI measurement, where the CLI measurement time window corresponds to one or more time and frequency locations. The communications manager 1020 is capable of, configured to, or operable to support a means for performing the L1 UE to UE CLI measurement on the one or more aperiodic CLI-RSSI resources, the one or more aperiodic CLI SRS-RSRP resources, or during the CLI measurement time window.

Additionally, or alternatively, the communications manager 1020 may support wireless communication in accordance with examples as disclosed herein. For example, the communications manager 1020 is capable of, configured to, or operable to support a means for receiving a configuration message that indicates a time window for an L1 UE to UE CLI measurement, where the configuration message indicates one or more time and frequency locations associated with the CLI measurement time window. The communications manager 1020 is capable of, configured to, or operable to support a means for receiving a control message that triggers the CLI measurement time window for the L1 UE to UE CLI measurement. The communications manager 1020 is capable of, configured to, or operable to support a means for performing the L1 UE to UE CLI measurement during the CLI measurement time window.

By including or configuring the communications manager 1020 in accordance with examples as described herein, the device 1005 may support techniques for improved communication reliability, reduced latency, more efficient utilization of communication resources, improved coordination between devices, and improved utilization of processing capability, among other examples.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of time window-based CLI measurement and reporting as described herein, or the at least one processor 1040 and the at least one memory 1030 may be otherwise configured to, individually or collectively, perform or support such operations.

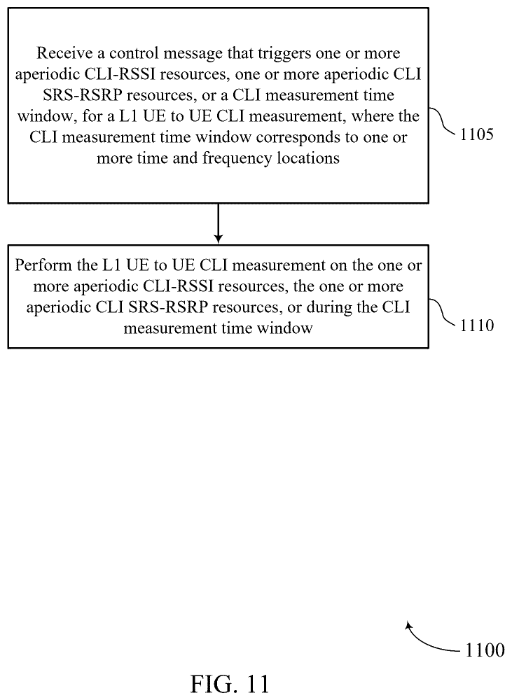

FIG. 11 shows a flowchart illustrating a method 1100 that supports time window-based CLI measurement and reporting in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a control message that triggers one or more aperiodic CLI-RSS) resources, one or more aperiodic CLI SRS-RSRP resources, or a CLI measurement time window, for an L1 UE to UE CLI measurement, where the CLI measurement time window corresponds to one or more time and frequency locations. The operations of 1105 may be performed in accordance with examples as disclosed herein. In some examples, aspects of the operations of 1105 may be performed by a control message component 925 as described with reference to FIG. 9.

At 1110, the method may include performing the L1 UE to UE CLI measurement on the one or more aperiodic CLI-RSSI resources, the one or more aperiodic CLI SRS-RSRP resources, or during the CLI measurement time window. The operations of 1110 may be performed in accordance with examples as disclosed herein. In some examples, aspects of the operations of 1110 may be performed by a CLI measurement component 930 as described with reference to FIG. 9.

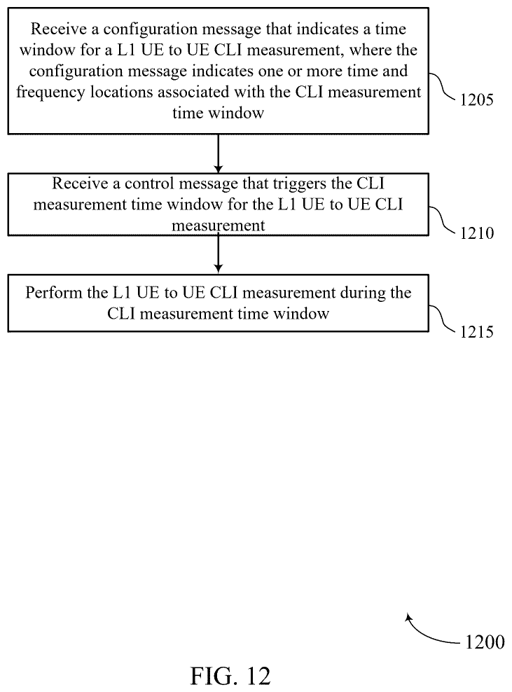

FIG. 12 shows a flowchart illustrating a method 1200 that supports time window-based CLI measurement and reporting in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving a configuration message that indicates a time window for an L1 UE to UE CLI measurement, where the configuration message indicates one or more time and frequency locations associated with the CLI measurement time window. The operations of 1205 may be performed in accordance with examples as disclosed herein. In some examples, aspects of the operations of 1205 may be performed by a configuration message component 935 as described with reference to FIG. 9.

At 1210, the method may include receiving a control message that triggers the CLI measurement time window for the L1 UE to UE CLI measurement. The operations of 1210 may be performed in accordance with examples as disclosed herein. In some examples, aspects of the operations of 1210 may be performed by a control message component 925 as described with reference to FIG. 9.

At 1215, the method may include performing the L1 UE to UE CLI measurement during the CLI measurement time window. The operations of 1215 may be performed in accordance with examples as disclosed herein. In some examples, aspects of the operations of 1215 may be performed by a CLI measurement component 930 as described with reference to FIG. 9.

The following provides an overview of aspects of the present disclosure:
Aspect 1: A method for wireless communication at a UE, comprising: receiving a control message that triggers one or more aperiodic CLI-RSSI resources, one or more aperiodic CLI SRS-RSRP resources, or a CLI measurement time window, for an L1 UE to UE CLI measurement, wherein the CLI measurement time window corresponds to one or more time and frequency locations; and performing the L1 UE to UE CLI measurement on the one or more aperiodic CLI-RSSI resources, the one or more aperiodic CLI SRS-RSRP resources, or during the CLI measurement time window.
Aspect 2: The method of aspect 1, further comprising: receiving a configuration message that indicates a set of CLI-RSSI resources or a set of CLI SRS-RSRP resources, and wherein the configuration message indicates a respective resource level slot offset for each respective CLI-RSSI resource of the set of CLI-RSSI resources or for each respective CLI SRS-RSRP resource of the set of CLI SRS-RSRP resources, wherein the L1 UE to UE CLI measurement is performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources according to the respective resource level slot offset for each of one or more aperiodic CLI-RSSI resources or the one or more aperiodic CLI SRS-RSRP resources.
Aspect 3: The method of aspect 2, wherein the control message is associated with a CLI measurement time window associated with the one or more aperiodic CLI-RSSI resources or the one or more aperiodic CLI SRS-RSRP resources for the L1 UE to UE CLI measurement, and the L1 UE to UE CLI measurement is performed on the one or more aperiodic CLI-RSSI resources or the one or more aperiodic CLI SRS-RSRP resources during the CLI measurement time window.
Aspect 4: The method of aspect 3, wherein each respective slot associated with the one or more aperiodic CLI-RSSI resources or the one or more aperiodic CLI SRS-RSRP resources occurs during the CLI measurement time window.
Aspect 5: The method of aspect 4, further comprising: obtaining a set of L1 UE to UE CLI measurement values based at least in part on the L1 UE to UE CLI measurement performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources that occurs during the CLI measurement time window; and transmitting a report comprising one or more L1 UE to UE CLI measurement values of the set of L1 UE to UE CLI measurement values based at least in part on the configuration message.
Aspect 6: The method of aspect 5, wherein the set of L1 UE to UE CLI measurement values comprises one or more RSRP values, one or more RSSI values, or a combination thereof.
Aspect 7: The method of any of aspects 5 through 6, wherein the one or more L1 UE to UE CLI measurement values satisfy a threshold L1 UE to UE CLI measurement value.
Aspect 8: The method of any of aspects 2 through 7, wherein the configuration message indicates a quantity of CLI-RSSI resources or CLI SRS-RSRP resources for reporting L1 UE to UE CLI measurement, and the report is transmitted based at least in part on the quantity of CLI-RSSI resources or CLI SRS-RSRP resources indicated in the configuration message.
Aspect 9: The method of aspect 8, wherein one or more reporting criterion associated with the report is based at least in part on a quantity of most interfering or least interfering CLI-RSSI resources or CLI SRS-RSRP resources.
Aspect 10: The method of any of aspects 2, 8, and 9, further comprising: identifying a respective resource set level slot offset for the set of CLI-RSSI resources or the set of CLI SRS-RSRP resources, wherein the respective resource level slot offset is applicable for the set of CLI-RSSI resources or the set of CLI SRS-RSRP resources; and bypassing a usage of the respective resource set level slot offset for the set of CLI-RSSI resources or the set of CLI SRS-RSRP resources based at least in part on the respective resource level slot offset for each respective CLI-RSSI resource of the set of CLI-RSSI resources or for each respective CLI SRS-RSRP resource of the set of CLI SRS-RSRP resources, wherein the L1 UE to UE CLI measurement is performed on the one or more aperiodic CLI-RSSI resources or the one or more aperiodic CLI SRS-RSRP resources based at least in part on the bypassing.
Aspect 11: The method of aspect 1, further comprising: receiving a configuration message that indicates a set of CLI-RSSI resources or a set of CLI SRS-RSRP resources, the set of CLI-RSSI resources or the set of CLI SRS-RSRP resources comprising a plurality of CLI-RSSI resources or CLI SRS-RSRP resources, respectively, wherein the configuration message indicates a different slot for each CLI-RSSI resource of the plurality of CLI-RSSI resources or each CLI SRS-RSRP resource of the plurality of CLI SRS-RSRP resources.
Aspect 12: The method of any of aspects 1 through 11, wherein the control message indicates a time duration between an ending slot associated with the control message and a beginning slot associated with the CLI measurement time window.
Aspect 13: The method of any of aspects 1 through 12, wherein the control message indicates a length of the CLI measurement time window.
Aspect 14: The method of any of aspects 1 through 13, wherein the control message indicates a quantity of symbols per slot to monitor and measure associated with the one or more aperiodic CLI-RSSI resources or the one or more aperiodic CLI SRS-RSRP resources, the quantity of symbols per slot are indicated via a bitmap or an indication of one or more symbol numbers.
Aspect 15: The method of any of aspects 1 through 14, wherein the control message indicates a quantity of subbands or bands to monitor and measure associated with the one or more aperiodic CLI-RSSI resources or the one or more aperiodic CLI SRS-RSRP resources for the L1 UE to UE CLI measurement.
Aspect 16: The method of any of aspects 1 through 15, wherein the L1 UE to UE CLI measurement performed on the one or more aperiodic CLI-RSSI resources or the one or more aperiodic CLI SRS-RSRP resources is associated with a plurality of neighbor equipment (UEs), a plurality of receive beams, a plurality of transmit beams, or a combination thereof.
Aspect 17: The method of any of aspects 1 through 16, further comprising: transmitting a capability message indicating a capability of the UE to support the L1 UE to UE CLI measurement on the one or more aperiodic CLI-RSSI resources or the one or more aperiodic CLI SRS-RSRP resources during the CLI measurement time window, wherein the control message is based at least in part on the capability message.
Aspect 18: A method for wireless communication at a UE, comprising: receiving a configuration message that indicates a time window for an L1 UE to UE CLI measurement, wherein the configuration message indicates one or more time and frequency locations associated with the CLI measurement time window; receiving a control message that triggers the CLI measurement time window for the L1 UE to UE CLI measurement; and performing the L1 UE to UE CLI measurement during the CLI measurement time window.
Aspect 19: The method of aspect 18, further comprising: obtaining a set of L1 UE to UE CLI measurement values based at least in part on the L1 UE to UE CLI measurement performed on one or more aperiodic CLI-RSSI resources or one or more aperiodic CLI SRS-RSRP resources and during each respective slot associated with the one or more aperiodic CLI-RSSI resources or the one or more aperiodic CLI SRS-RSRP resources that occurs during the CLI measurement time window; and transmitting a report comprising one or more L1 UE to UE CLI measurement values of the set of L1 UE to UE CLI measurement values based at least in part on the configuration message.
Aspect 20: The method of aspect 19, wherein the set of L1 UE to UE CLI measurement values comprises one or more RSRP values, one or more RSSI values, or a combination thereof.
Aspect 21: A UE for wireless communication, comprising one or more memories storing processor-executable code, and one or more processors coupled with the one or more memories and individually or collectively operable to execute the code to cause the UE to perform a method of any of aspects 1 through 17.
Aspect 22: A UE for wireless communication, comprising at least one means for performing a method of any of aspects 1 through 17.
Aspect 23: A non-transitory computer-readable medium storing code for wireless communication, the code comprising instructions executable by one or more processors to perform a method of any of aspects 1 through 17.
Aspect 24: A UE for wireless communication, comprising one or more memories storing processor-executable code, and one or more processors coupled with the one or more memories and individually or collectively operable to execute the code to cause the UE to perform a method of any of aspects 18 through 20.
Aspect 25: A UE for wireless communication, comprising at least one means for performing a method of any of aspects 18 through 20.
Aspect 26: A non-transitory computer-readable medium storing code for wireless communication, the code comprising instructions executable by one or more processors to perform a method of any of aspects 18 through 20.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message that triggers one or more aperiodic cross-link interference received signal strength indicator (CLI-RSSI) resources, one or more aperiodic CLI sounding reference signal received power (SRS-RSRP) resources, or a CLI measurement time window, for a layer one (L1) UE to UE CLI measurement, wherein the CLI measurement time window corresponds to one or more time and frequency locations; and
perform the L1 UE to UE CLI measurement on the one or more aperiodic CLI-RSSI resources, the one or more aperiodic CLI SRS-RSRP resources, or during the CLI measurement time window.

2. The UE of claim 1, wherein the one or more processors are individually or collectively further operable to execute the code to cause the UE to:
receive a configuration message that indicates a set of CLI-RSSI resources or a set of CLI SRS-RSRP resources, and wherein the configuration message indicates a respective resource level slot offset for each respective CLI-RSSI resource of the set of CLI-RSSI resources or for each respective CLI SRS-RSRP resource of the set of CLI SRS-RSRP resources, wherein the L1 UE to UE CLI measurement is performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources according to the respective resource level slot offset for each of one or more aperiodic CLI-RSSI resources or the one or more aperiodic CLI SRS-RSRP resources.

3. The UE of claim 2, wherein:
the control message is associated with a CLI measurement time window associated with the one or more aperiodic CLI-RSSI resources or the one or more aperiodic CLI SRS-RSRP resources for the L1 UE to UE CLI measurement, and
the L1 UE to UE CLI measurement is performed on the one or more aperiodic CLI-RSSI resources or the one or more aperiodic CLI SRS-RSRP resources during the CLI measurement time window.

4. The UE of claim 3, wherein each respective slot associated with the one or more aperiodic CLI-RSSI resources or the one or more aperiodic CLI SRS-RSRP resources occurs during the CLI measurement time window.

5. The UE of claim 4, wherein the one or more processors are individually or collectively further operable to execute the code to cause the UE to:
obtain a set of L1 UE to UE CLI measurement values based at least in part on the L1 UE to UE CLI measurement performed on the one or more aperiodic CLI-RSSI resources or the one or more aperiodic CLI SRS-RSRP resources and during each respective slot associated with the one or more aperiodic CLI-RSSI resources or the one or more aperiodic CLI SRS-RSRP resources that occurs during the CLI measurement time window; and
transmit a report comprising one or more L1 UE to UE CLI measurement values of the set of L1 UE to UE CLI measurement values based at least in part on the configuration message.

6. The UE of claim 5, wherein the set of L1 UE to UE CLI measurement values comprises one or more RSRP values, one or more RSSI values, or a combination thereof.

7. The UE of claim 5, wherein the one or more L1 UE to UE CLI measurement values satisfy a threshold L1 UE to UE CLI measurement value.

8. The UE of claim 2, wherein the configuration message indicates a quantity of CLI-RSSI resources or CLI SRS-RSRP resources for reporting L1 UE to UE CLI measurement, and wherein the one or more processors are individually or collectively further operable to execute the code to cause the UE to transmit the report based at least in part on the quantity of CLI-RSSI resources or CLI SRS-RSRP resources indicated in the configuration message.

9. The UE of claim 8, wherein one or more reporting criterion associated with the report is based at least in part on a quantity of most interfering or least interfering CLI-RSSI resources or CLI SRS-RSRP resources.

10. The UE of claim 2, wherein the one or more processors are individually or collectively further operable to execute the code to cause the UE to:
identify a respective resource set level slot offset for the set of CLI-RSSI resources or the set of CLI SRS-RSRP resources, wherein the respective resource level slot offset is applicable for the set of CLI-RSSI resources or the set of CLI SRS-RSRP resources; and
bypass a usage of the respective resource set level slot offset for the set of CLI-RSSI resources or the set of CLI SRS-RSRP resources based at least in part on the respective resource level slot offset for each respective CLI-RSSI resource of the set of CLI-RSSI resources or for each respective CLI SRS-RSRP resource of the set of CLI SRS-RSRP resources, wherein the L1 UE to UE CLI measurement is performed on the one or more aperiodic CLI-RSSI resources or the one or more aperiodic CLI SRS-RSRP resources based at least in part on the bypassing.

11. The UE of claim 1, wherein the one or more processors are individually or collectively further operable to execute the code to cause the UE to:
receive a configuration message that indicates a set of CLI-RSSI resources or a set of CLI SRS-RSRP resources, the set of CLI-RSSI resources or the set of CLI SRS-RSRP resources comprising a plurality of CLI-RSSI resources or CLI SRS-RSRP resources, respectively, wherein the configuration message indicates a different slot for each CLI-RSSI resource of the plurality of CLI-RSSI resources or each CLI SRS-RSRP resource of the plurality of CLI SRS-RSRP resources.

12. The UE of claim 1, wherein the control message indicates a time duration between an ending slot associated with the control message and a beginning slot associated with the CLI measurement time window.

13. The UE of claim 1, wherein the control message indicates a length of the CLI measurement time window.

14. The UE of claim 1, wherein the control message indicates a quantity of symbols per slot to monitor and measure associated with the one or more aperiodic CLI-RSSI resources or the one or more aperiodic CLI SRS-RSRP resources, wherein the quantity of symbols per slot are indicated via a bitmap or an indication of one or more symbol numbers.

15. The UE of claim 1, wherein the control message indicates a quantity of subbands or bands to monitor and measure associated with the one or more aperiodic CLI-RSSI resources or the one or more aperiodic CLI SRS-RSRP resources for the L1 UE to UE CLI measurement.

16. The UE of claim 1, wherein the L1 UE to UE CLI measurement performed on the one or more aperiodic CLI-RSSI resources or the one or more aperiodic CLI SRS-RSRP resources is associated with a plurality of neighbor equipment (UEs), a plurality of receive beams, a plurality of transmit beams, or a combination thereof.

17. The UE of claim 1, wherein the one or more processors are individually or collectively further operable to execute the code to cause the UE to:
transmit a capability message indicating a capability of the UE to support the L1 UE to UE CLI measurement on the one or more aperiodic CLI-RSSI resources or the one or more aperiodic CLI SRS-RSRP resources during the CLI measurement time window, wherein the control message is based at least in part on the capability message.

18. A user equipment (UE), comprising:
one or more memories storing processor-executable code; and
one or more processors coupled with the one or more memories and individually or collectively operable to execute the code to cause the UE to:
receive a configuration message that indicates a time window for a layer one (L1) UE to UE cross-link interference (CLI) measurement, wherein the configuration message indicates one or more time and frequency locations associated with the CLI measurement time window;
receive a control message that triggers the CLI measurement time window for the L1 UE to UE CLI measurement; and
perform the L1 UE to UE CLI measurement during the CLI measurement time window.

19. The UE of claim 18, wherein the one or more processors are individually or collectively further operable to execute the code to cause the UE to:
obtain a set of L1 UE to UE CLI measurement values based at least in part on the L1 UE to UE CLI measurement performed on one or more aperiodic cross-link interference received signal strength indicator (CLI-RSSI) resources or one or more aperiodic CLI sounding reference signal received power (SRS-RSRP) resources and during each respective slot associated with the one or more aperiodic CLI-RSSI resources or the one or more aperiodic CLI SRS-RSRP resources that occurs during the CLI measurement time window; and
transmit a report comprising one or more L1 UE to UE CLI measurement values of the set of L1 UE to UE CLI measurement values based at least in part on the configuration message.

20. A method for wireless communication at a user equipment (UE), comprising:
receiving a control message that triggers one or more aperiodic cross-link interference received signal strength indicator (CLI-RSSI) resources, one or more aperiodic CLI sounding reference signal received power (SRS-RSRP) resources, or a CLI measurement time window, for a layer one (L1) UE to UE CLI measurement, wherein the CLI measurement time window corresponds to one or more time and frequency locations; and
performing the L1 UE to UE CLI measurement on the one or more aperiodic CLI-RSSI resources, the one or more aperiodic CLI SRS-RSRP resources, or during the CLI measurement time window.
